(19) United States
(12) Patent Application Publication
(10) Pub. No.: US 2002/0159816 A1
(43) Pub. Date: Oct. 31, 2002

(54) Document protection and display assembly

(75) Inventors: Frederick J. Gagnon JR., Chicopee, MA (US); Alice Chou, Walnut, CA (US)

Correspondence Address: OPPENHEIMER WOLFF & DONNELLY LLP, 38th Floor, 2029 Century Park East, Los Angeles, CA, 90067-3024, US

(73) Assignee: Avery Dennison Corporation

(21) Appl. No.: 09/843,590

(22) Filed: Apr. 25, 2001

(51) Int. Cl. B41J 29/00

(52) U.S. Cl. 400/719

(57) ABSTRACT

A document protection and mounting assembly includes a document protection envelope of thin flexible transparent plastic for receiving 8½×11-inch paper, A-4 paper, 8½×14-inch paper, or other standard sheets; and the envelope is provided with areas at the top and bottom and near each corner of permanent adhesive bonded to the envelope and repositionable pressure sensitive adhesive overlying the permanent adhesive, and release coated liners overlying the PSA, whereby said liners may be removed and said envelope may be mounted on virtually any available surface to provide protected printing in any desired accessible location.

### BACKGROUND OF THE INVENTION

1. Field of the Invention

This invention relates to arrangements for protecting a document and mounting it for viewing.

2. General Background and State of the Art

Document protectors are known, and they have characteristically used a pair of sheets of transparent plastic such as polypropylene, which are bonded together on three sides with a fourth side being open to receive a sheet or document such as an 8½×11-inch sheet which is to be protected, but which is available for viewing. These document protection envelopes often have one extended edge provided with punched holes, so that the protected document may be mounted in a three-ring binder or the like.

### INVENTION SUMMARY

One object of the present invention is to both protect a document or printed sheet and also to mount the protected document or sheet in virtually any desired location.

In accordance with one illustrative embodiment of the invention, a document protection and display assembly may include an envelope formed of two substantially coextensive layers of flexible transparent plastic, with three closed edges and the fourth pair of edges being open to receive the document or printed sheet to be protected. The sheet or document would normally be substantially 8½×11-inches in size, to include A-4 paper, so the transparent envelope is preferably somewhat larger, such as about 9 inches wide and 11¼ to 11½ inches long. In order to mount the document protector to any desired surface, selected areas are provided at the top and bottom and adjacent each corner thereof, with permanent adhesive in engagement with the envelope, and with repositionable pressure sensitive adhesive (PSA) overlying the permanent adhesive, and with a release coated liner overlying the repositionable PSA; and the repositionable PSA may optionally be separated from the permanent adhesive by a layer of transparent plastic sheet material or a fluidically applied separation layer such as shellac, varnish or other relatively inactive material.

Viewed from another aspect, the securing arrangements for a preferred embodiment may include the following construction. Specifically, a tape which may be about ½-inch wide and about 8 inches long may be mounted symmetrically adjacent one of the 9-inch sides of assembly and may be adhered to the envelope by permanent adhesive. A second similar tape may be bonded adjacent the other 9-inch side of the assembly. On the outer side of the two tapes, a layer of a repositionable pressure sensitive adhesive is provided, to adhere the assembly to any desired surface. Finally, a release coated liner may overlay the repositionable adhesive, to protect the adhesive in storage, and before the assembly is mounted in the desired location. With the two tapes located as set forth above, it is noted that all four corners of the document protector are held in place so that the document protector is not easily accidentally displaced.

The tape is preferably positioned to hold the document protector both top and bottom; and may be in the form of four shorter lengths of tape (with adhesive and a liner as noted above) adjacent the four corners of the document protector.

With regard to the construction of the document protection and display assembly, various embodiments may include the following:

(1) One of the two overlying sheets may be slightly smaller than the other, for example at the open end of the envelope, to facilitate insertion of documents, and in such cases the two sheets are still substantially coextensive.

(2) The assembly could include more than two overlying sheets to form a plurality of overlying pockets.

(3) The pressure sensitive adhesive used for securing the assembly to a substrate may have any desired permanence, from an easily repositionable adhesive, which will generally be preferred, to a very aggressive permanent adhesive which would make it difficult to remove the assembly, once mounted in place.

(4) Instead of a single big envelope, the two layers or sheets of transparent material could involve a rear sheet which is a full size sheet and the front layer or sheet could be cut and secured to the rear sheet to form two or more smaller front pockets.

Other objects, features and advantages of the invention will become apparent from a consideration of the following detailed description and from the accompanying drawings.

### BRIEF DESCRIPTION OF THE DRAWINGS

FIG. 1 is a top plan view of a document protection and display assembly illustrating the principles of the invention;

FIG. 2 shows the assembly of FIG. 1 mounted on a door to display a message to persons approaching the door;

FIG. 3 is a fragmentary cross-sectional view taken along the plane 3-3 of FIG. 1; and

FIG. 4 is a view of an alternative document protection and display assembly shown mounted on the inside of a three-ring binder cover.

### DETAILED DESCRIPTION OF THE PREFERRED EMBODIMENTS

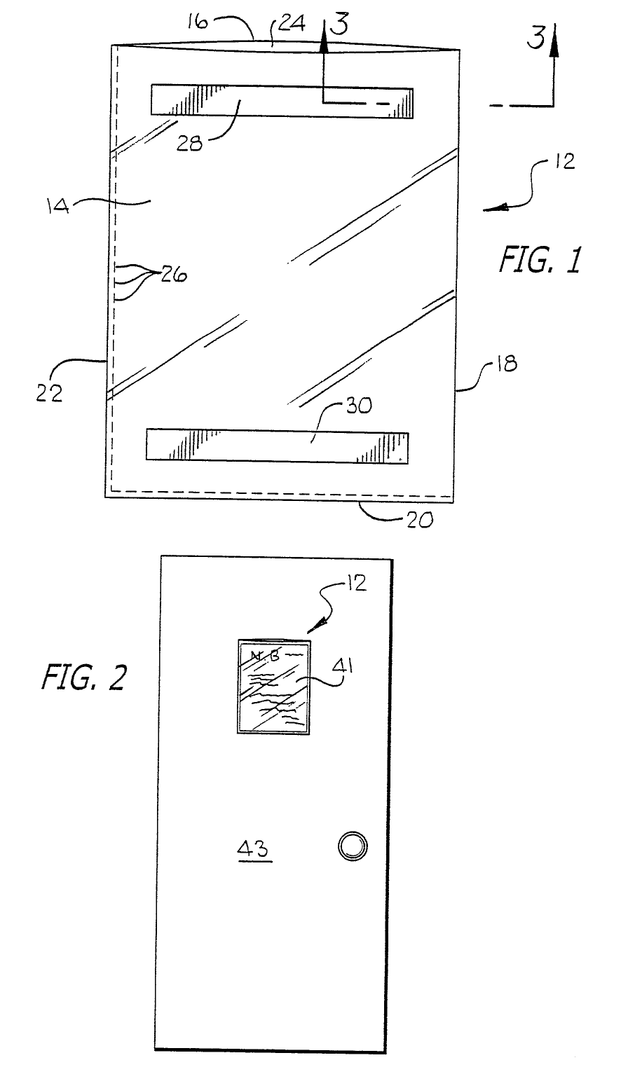

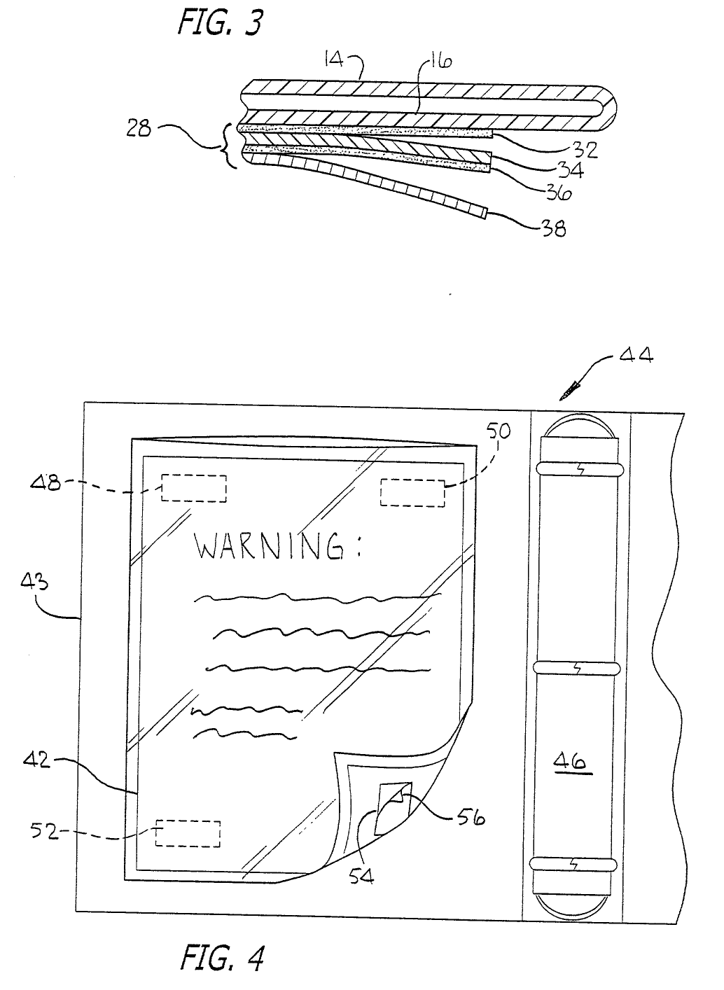

Referring more particularly to the drawings, FIG. 1 is a plan view of a document protection and display assembly 12, with FIG. 3 showing a cross-sectional view taken along the plane 3-3 of FIG. 1. The assembly 12 of FIG. 1 includes two substantially coextensive upper and lower flexible transparent sheets 14 and 16, which may, for example, be formed of polypropylene, or other thin transparent flexible plastic material.

The upper and lower sheets 14, 16 are secured together along three edges 18, 20 and 22 to form an envelope, open at the top or fourth edge 24 to receive a document or sheet to be displayed. The transparent plastic envelope may be formed of a single large sheet folded over at edge 18, and bonded together in any desired manner, with a series of closely spaced welds or heat bonding lines being shown along edges 20 and 22. In the event that two separate overlying sheets are used, the edges 18 may also be heat bonded.

Mounted on the rear of the lower sheet 16 are upper and lower mounting strips 28 and 30. These strips 28 and 30 may be about ½×-inch wide, about 8 inches long, and may be mounted symmetrically about ½×-inch from the upper and lower edges of the assembly. As shown to advantage in the fragmentary cross-sectional view of FIG. 3, the strips 28 and 30 may include a layer of permanent adhesive 32 permanently bonding the thin flexible transparent plastic strip 34 to the lower sheet 16 of the assembly 12.

On the other side of the strip 34 is a repositionable pressure sensitive adhesive (PSA) layer 36. The final layer 38 overlying the PSA layer 36 is a liner 38 which may be formed of paper or other sheet material. On the inner surface of the liner 38 is a very thin release layer such as silicone, which permits easy removal of the liner 38 to expose the PSA layer 36 when it is desired to mount the assembly for display. In one embodiment of the invention which has been successfully tested, the layers 32, 34 and 36 of FIG. 3 were implemented using a tape available from 3M Company, with the tape being designated by Stock No. 666. However, the layers as shown in FIG. 3 may be applied individually and successively, or in any desired pre-assembled combinations.

Incidentally, each of the plastic sheet material layers shown in FIG. 3 are only a few mils thick, and the adhesive layers in the order of one or two mils thick, so the layers are shown in FIG. 3 with exaggerated thickness to facilitate the description of these layers.

FIG. 2 shows one typical use of the document protector 12, with a document or printed sheet 41 having been inserted into the pocket of the assembly. The liners 38 have been removed from the two strips 28 and 30, and the assembly has been mounted on the door 43. In the specific application shown in FIG. 2, the sheet 41 may have a specific warning or instructions printed on it, and these are prominently brought to the attention of anyone using the door 43 or in the vicinity of the door.

FIG. 4 of the drawings shows a document display and protector assembly 42 mounted to the inside cover 43 of a three-ring notebook 44, with the ring assembly 46 for holding punched papers being generally conventional.

The document protector and mounting assembly 42 is generally similar to the assembly of FIGS. 1 and 3, but instead of the strips 28 and 30, it has four short lengths of tape 48, 50, 52 and 54. The tape strip 54 is shown in the process of application to the notebook cover 43, with the liner strip 56 being removed from the strip 54 to expose the repositionable pressure sensitive adhesive as discussed hereinabove in connection with FIG. 3. Incidentally, the short strips 48, 50, 52 and 54 have substantially the same construction as shown in FIG. 3, with an inner layer of permanent adhesive (which may be of any type, such as a permanent pressure sensitive adhesive) to bond the strips to the document protector, an intermediate layer of transparent plastic sheet material, an outer layer of repositionable PSA, and a final outer releasable liner 56.

Concerning the formation of the basic document protector structure, it may be formed from a large roll of flexible transparent sheet plastic which is between 11 and 12 inches wide. A length of about 18 inches is unrolled from the large roll, and is folded over to form a 9×11½-inch double layer product, and is heat bonded as indicated by the dashed lines 26 in FIG. 1. The resultant envelope with one open side is then cut off from the roll.

In conclusion, it is noted that the foregoing detailed description and associated drawings relate to embodiments illustrating the principles of the invention. However, various changes and modifications may be made without departing from the spirit and scope of the invention. Thus, by way of example and not of limitation, instead of documents or sheets approximately 8½×11 inches (including A-4 paper sheets) and a slightly larger assembly, other standard size sheets, such as 8½×14 inches in size, the usual legal size papers, may be accommodated using a document protection and mounting assembly size which is slightly larger. Concerning the intermediate layer 34 as shown in FIG. 3, between the permanent and repositionable adhesive, this may be a sprayed-on or liquid applied inactive intermediate layer, such as a shellac or varnish, or the repositionable adhesive may be applied directly onto the permanent adhesive layer. Also, the three layers 32, 34 and 36 (and also layer 38) may be applied to the underlying document protector as a tape, or may be applied in successive layers directly onto the document protector structure. It is further noted that instead of being rectangular or square, the adhesive areas may be of other shapes such as circular, ring shaped or of any other convenient configuration. In addition, although the entire assembly including adhesives and plastic sheet material is preferably transparent, the rear sheet, the adhesive and tapes may be opaque as they are normally concealed by the inserted document or message sheet. It is further noted that where the term “liner” is employed, it may refer to paper or plastic sheet material, for examples, which cover and protect pressure sensitive material, and which are removed when it is desired to mount the assembly on a mounting surface. Accordingly, the present invention is not limited to the precise embodiments as shown in the drawings and described in detail hereinabove.

What is claimed is:

1. A document protector and display assembly comprising:
a document protection envelope including at least two substantially coextensive layers of thin flexible transparent plastic having three closed edges and the fourth side open; said envelope being approximately 9 inches wide and approximately 11¼ to 11½ inches long, with one of the 9-inch sides open;
a first tape approximately 8 inches long and approximately ½-inch wide symmetrically located approximately one-half inch from the edge of the envelope;
a second tape of similar size and dimensions located approximately one-half inch from the other 9-inch edge of said envelope;
layers of permanent adhesive bonding each of said tapes to said document protection envelope;
each of said tapes having an additional repositionable pressure sensitive adhesive on the outer surface thereof;
a release coated liner overlying said layer of repositionable pressure sensitive adhesive on each of said tapes; and
at least one sheet of paper having dimensions of approximately 8½×11-inches, or A-4 paper mounted inside said transparent envelope and said sheet having printing thereon visible from outside of said envelope;
whereby said liners may be removed and said envelope may be mounted on virtually any available surface to provide protected printing in any desired accessible location.

2. An assembly as defined in claim 1 wherein said coextensive layers are formed from a single sheet folded over to form one edge of said envelope, and wherein two additional edges are heat bonded together.

3. A document protector and display assembly comprising:
at least two substantially coextensive layers of thin flexible transparent plastic forming at least one envelope, said envelope having three closed edges and the fourth side open; said envelope being approximately 9 inches wide and approximately 11¼ to 11½ inches long, with one of the 9-inch sides open;
said document protection envelope being held in place adjacent the four corners thereof by sections of tape;
layers of permanent pressure sensitive adhesive bonding each of said tapes to said document protection envelope;
each of said tapes having an additional pressure sensitive adhesive on the outer surface thereof;
a release coated liner overlying said layer of additional pressure sensitive adhesive on each of said tapes; and
at least one sheet of paper having dimensions of approximately 8½×11-inches, or A-4 paper, mounted inside said transparent envelope and said sheet having printing thereon visible from outside of said envelope;
whereby said liners may be removed and said envelope may be mounted on virtually any available surface to provide protected printing in any desired accessible location.

4. An assembly as defined in claim 3 wherein said coextensive layers are formed from a single sheet folded over to form one edge of said envelope, and wherein two additional edges are heat bonded together.

5. An assembly as defined in claim 3 wherein said additional pressure sensitive adhesive is repositionable pressure sensitive adhesive.

6. A document protection and mounting assembly comprising:
a document protection envelope including at least two substantially coextensive layers of thin, flexible, transparent plastic, said envelope having three closed edges and a fourth side open to receive standard size sheets of paper with written material thereon, said envelope being slightly greater in height and width than standard size sheets of paper to easily receive the sheets in unfolded configuration;
a plurality of predetermined areas of permanent adhesive in engagement with said envelope near the corners thereof;
a plurality of areas of repositionable pressure sensitive adhesive overlying said predetermined areas; and
release coated sheet liner material overlying said repositionable pressure sensitive adhesive;
whereby said liners may be removed and said envelope may be mounted on virtually any available surface to provide protected printing in any desired accessible location.

7. An assembly as defined in claim 6 wherein said coextensive layers are formed from a single sheet folded over to form one edge of said envelope, and wherein two additional edges are heat bonded together.

8. An assembly as defined in claim 6 wherein a printed sheet substantially 8½×11 inches in size is mounted within said envelope, and wherein the dimensions of said envelope are substantially greater than 8½×11 inches to readily receive said sheet.

9. An assembly as defined in claim 6 wherein said permanent adhesive and said repositionable adhesive are separated by flexible plastic sheet material.

10. An assembly as defined in claim 6 wherein said permanent adhesive and said repositionable adhesive are separated by a layer of inactive material.

11. An assembly as defined in claim 6 wherein a printed sheet substantially 8½×14 inches in size is mounted within said envelope, and wherein the dimensions of said envelope are substantially greater than 8½×14 inches to readily receive said sheet.

12. An assembly as defined in claim 6 wherein four sections of tape are mounted respectively at the corners of said envelope, with the sections of tape having the permanent adhesive bonding the sections of tape to the envelope, and wherein said sections of tape have an outer coating of said PSA.

13. An assembly as defined in claim 6 wherein said liner sheet material is paper.

14. An assembly as defined in claim 6 wherein said layers of plastic are formed of polypropylene.

15. An assembly as defined in claim 6 wherein said envelope and said adhesives are transparent.

16. An assembly as defined in claim 9 wherein said flexible sheet material and said adhesives are transparent.

17. A document protection and mounting assembly comprising:
at least two substantially coextensive layers of thin, flexible plastic, forming at least one envelope, at least one of said layers being transparent, said envelope having three closed edges and a fourth side open to receive standard size sheets of paper with written material thereon, said envelope being slightly greater in height and width than standard size sheets of paper to easily receive the sheets in unfolded configuration;
a plurality of predetermined areas of permanent adhesive in engagement with said envelope near the corners thereof;
a plurality of areas of repositionable pressure sensitive adhesive overlying said predetermined areas; and
release coated sheet liner material overlying said repositionable pressure sensitive adhesive;
whereby said liners may be removed and said envelope may be mounted on virtually any available surface to provide protected printing in any desired accessible location.

18. An assembly as defined in claim 17 wherein a printed sheet substantially 8½×11 inches in size is mounted within said envelope, and wherein the dimensions of said envelope are substantially greater than 8½×11 inches to readily receive said sheet.

19. An assembly as defined in claim 17 wherein said permanent adhesive and said repositionable adhesive are separated by flexible plastic sheet material.

20. An assembly as defined in claim 17 wherein said permanent adhesive and said repositionable adhesive are separated by a layer of inactive material.

21. An assembly as defined in claim 17 wherein said layers of plastic are formed of polypropylene.
